(19) United States
(12) Patent Application Publication
(10) Pub. No.: US 2010/0082611 A1
(43) Pub. Date: Apr. 1, 2010

(54) Trajectory Data Surfacing System: Surfacing Useful and Relevant Entity Annotations

(75) Inventors: Athellina Athsani, San Jose, CA (US); Elizabeth Frances Churchill, San Francisco, CA (US); Michael Cameron Jones, San Jose, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/236,353

(22) Filed: Sep. 23, 2008

(51) Int. Cl. G06F 17/30

(52) U.S. Cl. 707/724; 707/E17.009

(57) ABSTRACT

Multiple entities are tracked over periods of time and information concerning these entities are collected. For each entity, the entities associated with the entity and the types of associations are determined. One or more entities of interest is/are identified. Different weights are assigned to the entities on the trajectories connecting with the entity or entities of interest based on their associations with the entity or entities of interest and their positions on the trajectories. Selected entities are ranked and surfaced based on their total weights for the entity or entities of interest.

### TECHNICAL FILED

The present disclosure generally relates to collecting, maintaining, aggregating, categorizing, analyzing, and surfacing trajectory data concerning multiple entities and their associations with each other. More specifically, a trajectory within a network of entities interconnected via their associations represents a sequence of associations among at least some of the entities, and selected entities on the trajectories connecting with an entity of interest are ranked for the entity of interest based on their weights with respect to the entity of interest.

### BACKGROUND

When working with large sets of data containing thousands or millions of data points, often selected data points are related to one another in some ways. That is, different types of relationships exist among selected data points. Some of these relationships are know, while other relationships may not be readily apparent. By analyzing these data points and their relationships, certain types of patterns may emerge, and these patterns may then be used in different applications.

For example, many e-commerce websites make product recommendations to their customers. To do so, in one instance, the websites collect information concerning their customers' past purchases and other relevant information, such as the customers' background and personal information. The data is aggregated and analyzed based on various algorithms to determine purchasing patterns, which may then be used to make product recommendations.

Methods and algorithms have been developed for filtering, selecting, analyzing, aggregating, categorizing, and prioritizing data points belonging to large data sets. These method and algorithms often serve different purposes or focus on different applications.

### SUMMARY

Broadly speaking, the present disclosure generally relates to collecting, processing, and surfacing trajectory data.

According to various embodiments, multiple entities are tracked over periods of time and various types of information concerning these entities are collected. An entity is a generic term that refers to any subject matter, both physical and virtual (i.e., non-physical). For example, an entity may be a person, an object, an item, an action, a location, a time, a web page, a website, a message, an event, etc. When two entities interact or come in contact, they become associated with each other and a relationship exists between them. Many different types of associations exist between various entities.

For each entity being tracked, the entities associated with the entity and the types of associations are determined. The entities and their associations form a network of entities interconnected via their associations. A trajectory through the network represents a sequence of associations among at least some of the entities. Optionally, a context filter may be applied to the network to select a subset of entities and associations that satisfy a set of criteria.

For a given entity, referred to as “the entity of interest”, for which an analysis is performed, different weights are assigned to the entities on the trajectories connecting with the entity of interest based on the types of associations they have with the entity of interest and their positions on the trajectories. Different algorithms may be used to determine and calculate the weights assigned to the entities with respect to the entity of interest. Selected entities are then ranked for the entity of interest based on their respective total weights. Optionally, the ranking is conducted within specific context, such as temporal, spatial, social, topical, etc.

These and other features, aspects, and advantages of the disclosure will be described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIGS. 1A-1C illustrates associations an entity has in three different states.

FIG. 2 illustrates a group of entities where associations exist among selected entities.

FIG. 3 illustrates a method of ranking entities with respect to an entity of interest according to one embodiment of the present disclosure.

FIG. 4 illustrates a general computer system suitable for implementing embodiments of the present disclosure.

### DETAILED DESCRIPTION

The present disclosure will now be described in detail with reference to a few preferred embodiments thereof as illustrated in the accompanying drawings. In the following description, numerous specific details are set forth in order to provide a thorough understanding of the present disclosure. It will be apparent, however, to one skilled in the art, that the present disclosure may be practiced without some or all of these specific details. In other instances, well known process steps and/or structures have not been described in detail in order to not unnecessarily obscure the present disclosure. In addition, while the disclosure will be described in conjunction with the particular embodiments, it will be understood that this description is not intended to limit the disclosure to the described embodiments. To the contrary, the description is intended to cover alternatives, modifications, and equivalents as may be included within the spirit and scope of the disclosure as defined by the appended claims.

Information concerning multiple entities, especially a large number (e.g., thousands or millions) of entities, are often collected and processed in order to determine the various types of associations (i.e., relationships) existing among these entities. Some of these entity associations may be easily identified, while other associations may not be readily apparent. By studying these entities and their associations, various types of patterns (e.g., temporal, spatial, social, topical, behavioral, etc.) may emerge. These patterns may then be used in different applications.

According to various embodiments, multiple entities are tracked over periods of time and information concerning these entities is collected. An entity is a generic term that refers to any subject matter, both physical and virtual (i.e., non-physical). For example, an entity may be a person, an object, an item, an action, a location, a time, a web page, a website, a message, an event, etc. When two entities interact or come in contact, they become associated with each other and a relationship exists between them. A particular entity often has associations with different entities at different times.

There are many different types of associations that may exist between two entities. Sometimes, associations among the entities are tenuous at best. For example, when two people happened to have lunch at the same restaurant on the same day, an association exists between these two people even though they are complete strangers and there is no direct or obvious relationship between them. An association exists between these two people (i.e., two entities) merely because they were at the same place around the same time, and thus had come in contact with each other despite the fact that they might not even be aware of each other's presence in the restaurant. In this case, the association between the two entities is contiguous; that is, the two entities have merely co-occurred.

Other times, associations among the entities are closer or more direct. For example, an association may exist between two people who have been friends for many years. In this case, the association is stronger due to the long-term friendship between these two entities. Alternatively, an association between two entities may be a cause-and-effect relationship. In another example, an occurrence of an event X may have a certain result Y. In this case, the event entity X is the cause of the result entity Y; that is, when X happens, Y results. The association between X and Y is contingent. In fact, it is possible for any type of association to exist between two entities.

The entities and their associations form a network of entities interconnected via associations. Within such a network, a trajectory represents a sequence of associations among at least some of the entities, that is, a path from one entity to another entity and so on connected by the associations among these entities.

Selected entities may then be ranked (i.e., surfaced) for a particular entity, referred to as “the entity of interest,” based on their associations, either direct or indirect, with the entity of interest. More specifically, for an entity of interest for which an analysis is performed, those entities on the trajectories connected with the entity of interest are assigned different weights based on the types of associations they have with the entity of interest and their positions on the trajectories leading away from the entity of interest. Different algorithms may be used to determine or calculate the weights assigned to the entities with respect to the entity of interest. For example, weight values may be predefined for individual types of associations, with closer or stronger associations having higher weight values. Alternatively or in addition, associations may be organized into different categories and weight values may be predefined for each category of associations. Alternatively or in addition, weight values for various types of associations may be adjusted or refined over time as more information about the entities and their associations become available or as the algorithms “learn” what associations are more important or more direct or closer. In other words, the algorithms may be heuristic and may automatically determine and adjust weight values for the entity associations based on all or some of the available data. Selected entities are then ranked and/or surfaced (i.e., brought out) for the entity of interest based on their total weights with respect to the entity of interest.

There are many ways to track and collect information concerning entities. In fact, different methods are often employed to track different types of entities and obtain different types of information. Information may be provided explicitly or implicitly. For example, a person may be tracked via a mobile electronic device he or she carries, such as a mobile telephone or a GPS (global positioning system) locator. An object may be identified and tracked via barcode or RFID (radio-frequency identification). When a person takes a digital photograph of an object, that object may be identified using image recognition software. When a person uses the Internet, his or her activities, such as browsing the web, reading his or her e-mails, chatting with friends, purchasing products at e-commerce websites may be tracked by the computer systems. When a person establishes an online account, he or she may input specific personal information, such as name, address, telephone numbers, gender, age, geographical location, employment status, marital status, etc.

Any information concerning an entity may be collected. For example, the information may indicate what or who the entity is, where the entity is or what action the entity takes at a specific time, with which other entities the entity interacts, how does an entity perform a task, what causes an entity to become associated with another entity, etc. The “who”, “what”, “where”, “when”, and “how” may together be referred to as W4 data.

According to various embodiments, W4 data provides information relating to the “who, what, where, when, and how” of interactions among the entities. The W4 data may be used to create profiles for these entities. Using social, spatial, temporal, behavior, topical, logical, etc. data available about a specific entity, every entity may be mapped and represented against all other known entities so that a graphical representation of the entities and their associations may be constructed.

In a real life scenario, suppose a person visits a modem art museum that hosts an exhibition of a particular artist on a Saturday morning. The person is a human entity (H1); the modern art museum is a location entity (L1), the exhibition is an event entity (Ev1), the artist of the exhibition is a subject matter entity (SM1), and Saturday morning is a time entity (T1). If the person carries a mobile device, such as a smart phone, then the mobile device is a device entity (D1) and may be used to track the person's movements and actions. If the person encounters a friend at the museum, then the friend is another human entity (H2). The person's movements may be tracked via the mobile device, via the actions the person takes, such as buying a ticket at the museum using his/her credit card, via the museum's surveillance system, or any other possible means.

Suppose the person likes the artist's works and wishes to learn more about the artist. The person uses the mobile device to search for information about the artist on the Internet. The mobile device is a device entity (D1) that indicates how the person searches for information about the artist on the Internet, and the search is an action entity (A1). If the person clicks on a web page from the search result, the click is another action entity (A2). If the person buys a book about the artist from an online bookstore, the purchase is an action entity (A3); the book is an object entity (O1); and the online bookstore is a website entity (WS1). The activities the person conducted online via the mobile device may be used to track which web sites the person visits, what book he/she purchases, etc.

Suppose after attending the exhibition, the person has lunch at a nearby restaurant. The lunch is an action entity (A4); the restaurant is a location entity (L2); and the time for the lunch is a time entity (T2). The credit card payment may be used to track the person's action and location at lunch time.

Certain information may be obtained implicitly as well (i.e., without specific data input from any of the entities). Suppose the person is traveling along a certain route. Then tracking system notes that the person visits several points of interest throughout the route and tracks the duration of time the person spends at each point. The tracking system is capable of gathering contextual data on each location if the data of the location is not explicitly given. For example, the tracking system may combine GPS data with map coordinates and contextual data available on the given location to determine the context of the location in relation to the person. If the person spends twenty seconds at point A and point A is determined to be a road, the tracking system may deduce that point A is a traffic light. In another example, if the person spends 3 hours at point B and point B is determined to be a museum, the system may determine an association between the person and the museum.

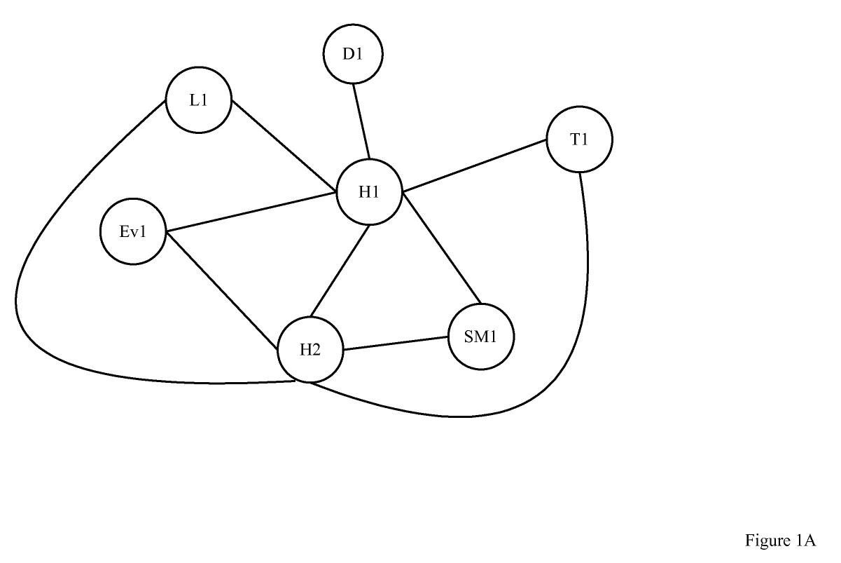

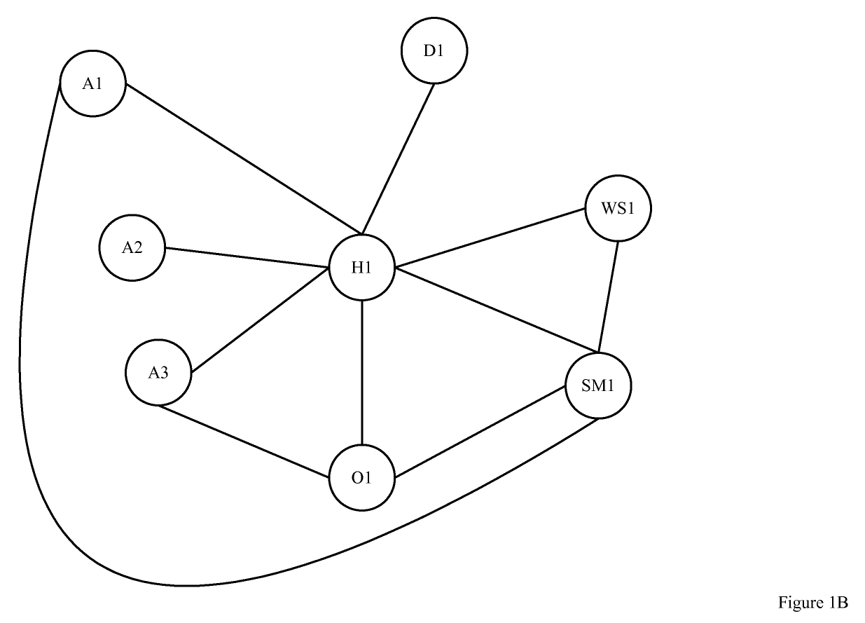

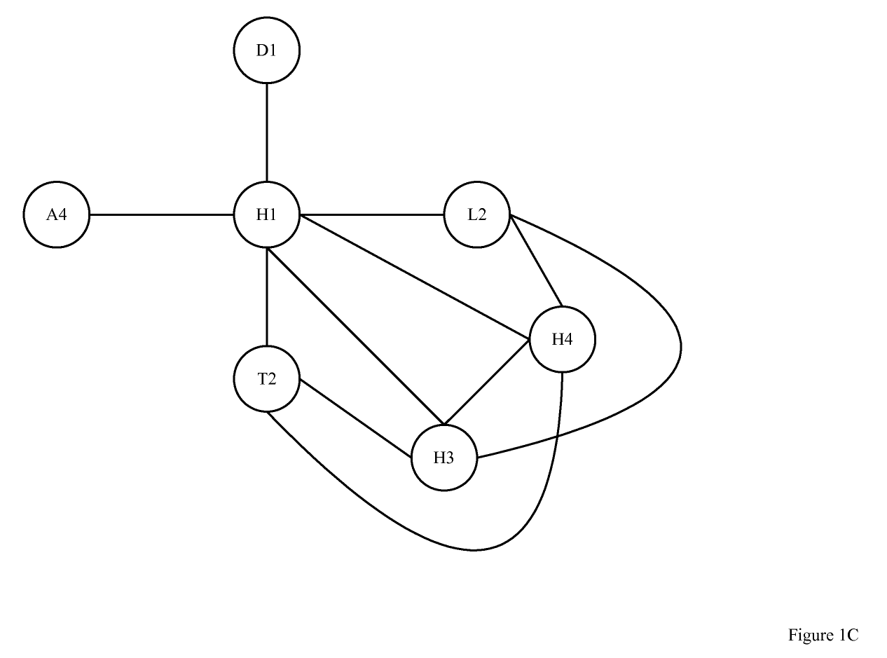

Thus, as an entity moves through time, the entity has associations with different entities at different times. Once information concerning multiple entities is collected, the data may be processed and categorized to determine the associations (i.e., the relationships) among the entities. The associations among the entities may be graphically represented. FIG. 1A illustrates the associations the person in the above scenario has at the modern art museum. Each node in the figure represents an entity. If an association exists between two entities, then the two entities are connected with a line (i.e., an edge). The person (H1) is associated with each of the following entities: the museum (L1), the exhibition (Ev1), the artist (SM1), Saturday morning (T1), mobile device (D1), and the friend (H2). Thus, a line connects the person (H1) to each of these entities.

In addition, the friend (H2) is also associated with the museum (L1), the exhibition (Ev1), the artist (SM1), and Saturday morning (T1), since the friend (H2) is attending the same exhibition around the same time. Thus, a line also connects the friend (H2) to the museum (L1), the exhibition (Ev1), the artist (SM1), and Saturday morning (T1) respectively.

FIG. 1B illustrates the associations the person in the above scenario has when searching for information about the artist online and purchasing a book about the artist. During this time, the person (H1) is associated with each of the following entities: the three actions (A1, A2, A3), the book (O1), the website (WS1), the device (D1), and the artist (SM1). In addition, the search action (A1) and the artist (SM1) are associated because the search is conducted on the artist. The book (O1) and the website (WS1) are associated because the website sells the book. The book (O1) and the artist (SM1) are connected because the book is about the artist.

FIG. 1C illustrates the associations the person in the above scenario has when having lunch after attending the art exhibition. During this time, the person (H1) is associated with each of the following entities: the mobile device (D1), the lunch (A4), the restaurant (L2), and the time of the lunch (T2).

In addition, there may be other customers (H3, H4) also having lunch at the restaurant (L2). Although there may not be any direct association between the person (H1) and the other customers (H3, H4), an association still exists between the person (H1) and the other customers merely because they are all having lunch at the same restaurant (L2) around the same time (T2). At the same time, each of the other customers (H3, H4) is associated with each other as well as with the restaurant (L2) and the time of lunch (T2).

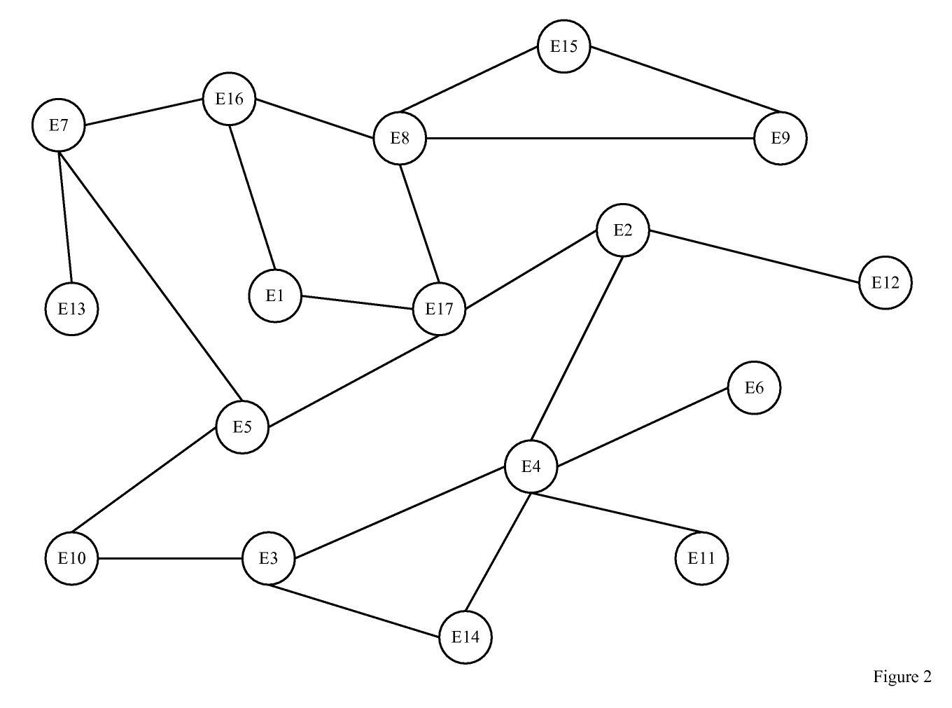

FIGS. 1A-1C illustrates a few associations mainly with respect to one entity, namely the person in the above scenario. When the same concept is extended to many entities, a network of entities and their associations may be constructed. The network includes multiple entities and the associations among these entities at different times. FIG. 2 illustrates a network of entities where associations exist among selected entities. The illustration is simplified. In practice, such a network often includes thousands or millions of entities. As before, each node in the graph represents an entity, each edge connecting two nodes represents an association between the two entities, and there are many types of entities and associations. Note that the graph is merely a way of visually illustrating the concept of the network, and it is not necessary to represent the network using such a graph. The network may be represented using other suitable data structures.

In the context of entities and their associations, a trajectory represents a sequence of associations from one entity to another entity and so on. Thus, in FIG. 2, one trajectory leads from E12 to E2 to E17 to E1 to E16 to E7 to E13. Another trajectory leads from E2 to E4 to E14. A third trajectory leads from E10 to E5 to E17 to E2 to E12. Furthermore, between two specific entities, there may be multiple trajectories leading from the first entity to the second entity. In FIG. 2, between E16 and E9, one trajectory includes entities E16, E8, and E9; another trajectory includes entities E16, E1, E17, E8, and E9; and a third trajectory includes entities E16, E8, E15, and E9.

Once a network of entities and their associations have been constructed, a trajectory data analysis algorithm may be applied to the entities and their associations in order to rank the entities based on the trajectories for a specific entity. According to various embodiments, the analysis is performed with respect to a particular entity (i.e., an entity of interest). A weight is assigned to each entity (i.e., node) on the trajectories leading away from the entity of interest. The weights represent the relative importance of the entities on the trajectories with respect to the entity of interest, and selected entities are then ranked based on their total weights.

There are many criteria that may be used to indicate or suggest how different weights are assigned to various entities with respect to the entity of interest. Different entities (i.e., nodes) are assigned different weights based on the types of associations they have with the entity (i.e., node) of interest. Suppose in FIG. 2, node E17 represents a person entity, which is selected as the entity of interest in this sample analysis. Node E17 has associations directly with nodes E1, E8, E2, and E5 representing four different entities respectively. With respect to the person represented by node E17, the four entities represented by nodes E1, E8, E2, and E5 may have different types of associations with the person.

According to some embodiments, closer associations are assigned higher weights. For example, suppose node E1 represents another person who is a close friend with the person represented by node E17. Thus, there is a close association between the person represented by node E17 and the person represented by node E1. The close association between E1 and E17 may be determined by, but not limited to, frequency of correspondence (tracked by phone calls, emails, or face to face meetings), explicit data such as same last names, associations in social networks etc. With respect to the person represented by node E17, the person represented by node E1 may be assigned a higher weight in order to indicate that the person represented by node E1 is relatively more important to the person represented by node E17.

Conversely, suppose node E2 represents a third person whom the person represented by node E17 has only met once. Thus, the association between the person represented by node E17 and the person represented by node E2 is tenuous at best. With respect to the person represented by node E17, the person represented by node E2 may be assigned a lower weight in order to indicate that the person represented by node E2 is relatively less important to the person represented by node E17.

Some actions are more important to an entity than others, and thus are assigned a higher weight. Suppose node E8 represents a book that the person represented by node E17 has purchased, and node E5 represents another book that the person represented by node E17 has examined but not purchased. Thus, between the two books, the book represented by node E8 is assigned a higher weight than the book represented by node E5, because the fact that the person represented by node E17 has purchased the book represented by node E8 suggests that this book is more important to the person than the book represented by node E5, which the person has not purchased. Furthermore, frequency of association between E8 and E17 or between E8 and other entities associated with E17 (closely or otherwise) may also contribute to the higher weight valuation.

According to some embodiments, newer associations may receive higher weights than older associations, especially in determining and/or surfacing seasonal or latest trend associations. Suppose, in a different scenario, nodes E1 and E8 represent two different restaurants that the person represented by node E17 has patronized. However, the person has been to the restaurant represented by node E1 more recently than the one represented by node E8. Thus, node E1 may receive a higher weight than node E8.

Sometimes, two entities are associated, either directly or indirectly, in multiple ways or multiple times. For example, a person may visit a particular bookstore or restaurant frequently. Frequent and repeated associations may also increase the weight assigned to an entity. Thus, the bookstore or restaurant that the person frequently visits may receive a higher weight with respect to the person than another store the person rarely visits.

Sometimes, a user may select or identify certain entities explicitly (e.g., via a user interface) so that these entities receive higher weights with respect to this specific user. For example, suppose a person likes Italian food especially. Consequently, the person may identify several of his or her Italian restaurants in his or her neighborhood to receive higher weights than the other restaurants.

Sometimes, certain entities are more important to a person within a certain context, such as with a social network to which the person belongs. For example, suppose many of the person's friends like a particular coffee shop and often meet at the shop on social occasions. As a result, the coffee shop is ranked higher within the person's social network.

According to some embodiments, weights assigned to entities are determined based on aggregated behavior of many people. In this case, there is a personal element to the weighting values assigned to the entities on the trajectories. If many people behave similarly (i.e., multiple people entities traversing similar trajectory paths involving similar entities, such as locations, actions, objects, etc.), then the weight values assigned to these entities are relatively higher. Conversely, if only a few people or one person traverse down a path, then the weight values assigned to the entities on this path may be relatively lower.

According to some embodiments, entities closer to the entity of interest on the trajectories generally are assigned higher weights than entities further away from the entity of interest. Again in FIG. 2, from node E17 (i.e., the entity of interest), one of the trajectories leading away from node E17 are formed by nodes E8, E15, and E9. Thus, with respect to the person represented by node E17, node E8 may be assigned a higher weight than node E15, which in turn may be assigned a higher weight than node E9, since the association between nodes E17 and E8 (i.e., direct association) is closer than the association between nodes E17 and E15 (i.e., one-step removed association), which in turn is closer than the association between nodes E17 and E9 (i.e., two-step removed association).

Sometimes, multiple trajectories may exist between two nodes. For example, in FIG. 2, there are two trajectories leading from node E17 to node E9. One trajectory is formed by nodes E17, E8, E15, and E9 (the first trajectory). Another trajectory is formed by nodes E17, E8, and E9 (the second trajectory). Thus, with respect to node E17, there are two different weights assigned to node E9, one based on first trajectory and the other based on the second trajectory. Node E9 may be assigned a lower weight based on the first trajectory and a higher weight based on the second trajectory since node E9 is further from node E17 in the first trajectory but closer to node E17 in the second trajectory.

In addition, a context filter may be applied to the network to select those nodes and associations that satisfy a certain set of criteria. For example, a time (i.e., temporal) filter may be used to filter out associations that are too old to provide any meaningful analysis. In one sample scenario, only those entities having associations with the person represented by node E17 within the past five years are selected for analysis. A geographic filter (i.e., special) may be used to limit the analysis to entities relatively local to the person represented by node E17. In another sample scenario, only those entities located within the same state or country as the person represented by node E17 are selected for analysis. Other types of context filters may be applied to select entities and associations that belong to a particular category, including social (e.g., only those entities within the person's social group are selected for analysis), topical (e.g., only those entities relating to a subject matter or theme are selected for analysis), etc.

Once the entities on the trajectories connecting a particular entity of interest have been assigned weights with respect to the entity of interest, selected entities may be ranked based on their total weights, and the ranking may be used to make recommendations to the entity of interest. For example, suppose a person is searching for a restaurant near his current location for lunch. There are seven restaurants within a five-mile radius of the person's current location. To make a recommendation to the person, the seven restaurants may be ranked based on their respective total weights. In this scenario, the person's current location is the location entity of interest. Suppose based on past information, many people, when looking for a restaurant for lunch from the location of interest, have eventually reached one particular restaurant (the first restaurant) out of the seven nearby restaurants, although these people may take different trajectories. With respect to the location of interest, the first restaurant may have a higher total weight than the other six restaurants because there are more trajectories leading from the location of interest to this restaurant. Then, the first restaurant may be recommended to the person before the other six restaurants. Of course, all seven restaurants may be recommended in the order of their respective total weights.

In the above scenario, when ranking the seven restaurants, there may be multiple entities of interest. First, the ranking analysis is performed for a particular person, who may be considered one entity of interest. Second, the ranking analysis is performed with respect to a particular location (i.e., the location where the person is currently at), and the location may be considered another entity of interest. Furthermore, there may be other known or unknown people who, in the past, have been at the same location searching for restaurants. Thus, it is possible that entities on trajectories may be ranked and/or surfaced with respect to multiple entities of interest.

According to some embodiments, the entities on the trajectories may receive multiple weight values depending on with which entity of interest (i.e., on which trajectory) the weight values are determined. For example, with respect to the person, the entities on the trajectories connecting to the person may be assigned weight values according to one algorithm or one set of criteria. With respect to the location, the entities on the trajectories connecting to the location may be assigned weight values according to another algorithm or another set of criteria. With respect to another person who has been at the same location searching for restaurants, the entities on the trajectories connecting to that person may be assigned weight values according to a third algorithm or a third set of criteria, and so on. Some of these entities (e.g., the restaurants) may be on multiple trajectories and thus may receive multiple weight values. When ranking these entities, such as the restaurants, the multiple weight values may be aggregated (e.g., summed or averaged) so that multiple trajectories are taking into consideration for the final ranking.

Similarly, when a person conducts a search of a particular subject matter on the Internet, the search results may be ranked based on their total weights with respect to the person conducting the search or the subject matter of the search (i.e., the entity of interest). Other applications for the ranking results include, for example, providing directions, selecting advertisements, setting or adjusting bid prices in ad auctions, etc.

In a scenario where the ranking system is weighing multiple entities of interests, the ranking system may use a graph-based algorithm to determine the weights of associations. For example, in determining the weight of book X for user H where user H has looked at book Y, book Z, and bought movie W, the ranking system compiles a graph-based algorithm. So, as multiple people traverse from W to Z, Z to Y, and Y to X, and all other points and possibilities in the space in the ranking system, these associations will strengthen the weighting between those points. The system may use a simple frequency counter to determine points of association (e.g., how many people went from Z to Y). Then, finding meaningful trajectories is a matter of following maximally weighted edges in the graph. Determining the stopping point for the traversal may be done by finding local ‘sinks’ (nodes with larger in-degree than out-degree) or stopping when the ranking system can no longer make an easy determination of where to go next (all out-bound edges are equally, lowly weighted). The system then orders the paths in decreasing rank.

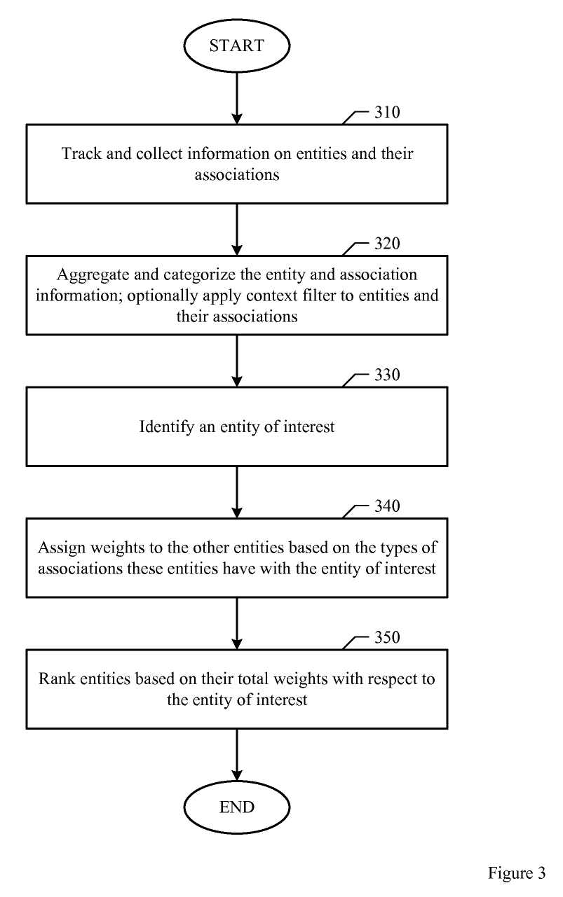

FIG. 3 illustrates a method of ranking entities with respect to an entity of interest according to one embodiment of the present disclosure. Entities are tracked over time via various means and their associations are determined explicitly or implicitly and collected (step 310). The collected information about the entities and their associations are aggregated and categorized; optionally, a context filter is applied to select a subset of entities and their associations (step 320). An entity of interest is identified for analysis (step 330). Different weights are assigned to the other entities on the trajectories leading from the entity of interest based on the types of associations they have with respect to the entity of interest and their positions on the trajectories (step 340). Sometimes, an entity may receive multiple weights if it lies on multiple trajectories leading away from the entity of interest. The entities are ranked based on the total weights they receive with respect to the entity of interest (step 350).

In one embodiment, the system also provides users with an interface to create, edit, and maintain associations between entities (e.g., artists are always associated with books for user A), weights between associations (e.g., Chinese restaurants always have higher weight than Mexican restaurants for user B).

In one embodiment, the data from the system is used as a recommendation and/or targeted query search/advertising tool. The different ranked associations can be used as the basis for surfacing query results that is customized to the entity.

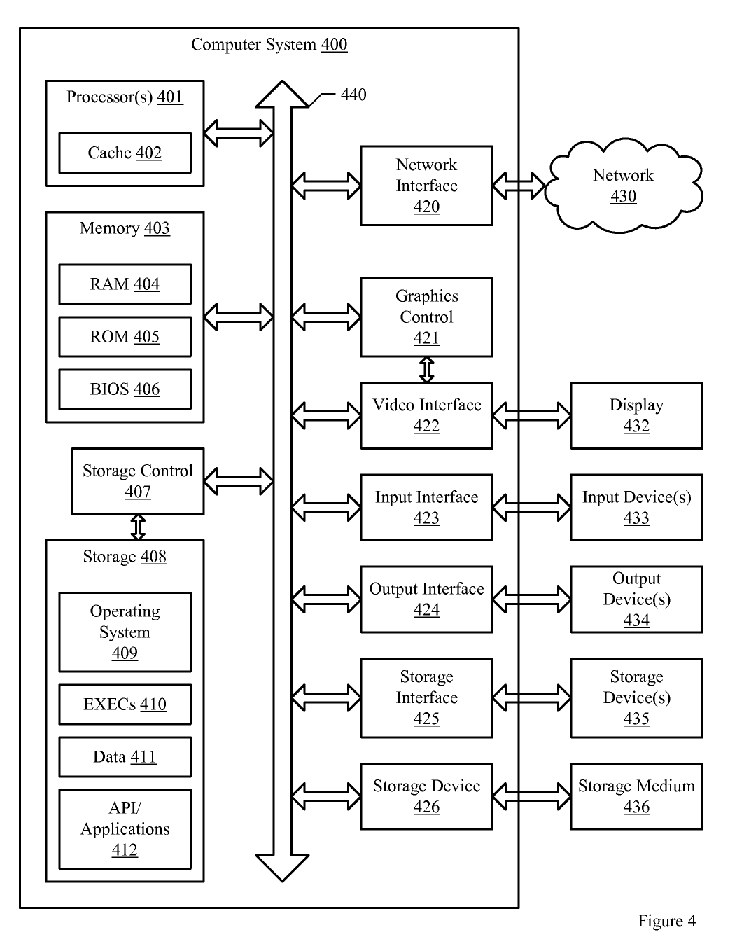

The method illustrated in FIG. 3 may be implemented as computer software using computer-readable instructions and stored in computer-readable medium. The software instructions may be executed on various types of computers. For example, FIG. 4 illustrates a computer system 400 suitable for implementing embodiments of the present disclosure. The components shown in FIG. 4 for computer system 400 are exemplary in nature and are not intended to suggest any limitation as to the scope of use or functionality of the API. Neither should the configuration of components be interpreted as having any dependency or requirement relating to any one or combination of components illustrated in the exemplary embodiment of a computer system. The computer system 400 may have many physical forms including an integrated circuit, a printed circuit board, a small handheld device (such as a mobile telephone or PDA), a personal computer or a super computer.

Computer system 400 includes a display 432, one or more input devices 433 (e.g., keypad, keyboard, mouse, stylus, etc.), one or more output devices 434 (e.g., speaker), one or more storage devices 435, various types of storage medium 436.

The system bus 440 link a wide variety of subsystems. As understood by those skilled in the art, a “bus” refers to a plurality of digital signal lines serving a common function. The system bus 440 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 401 (also referred to as central processing units, or CPUs) optionally contain a cache memory unit 402 for temporary local storage of instructions, data, or computer addresses. Processor(s) 401 are coupled to storage devices including memory 403. Memory 403 includes random access memory (RAM) 404 and read-only memory (ROM) 405. As is well known in the art, ROM 405 acts to transfer data and instructions uni-directionally to the processor(s) 401, and RAM 404 is used typically to transfer data and instructions in a bi-directional manner. Both of these types of memories may include any suitable of the computer-readable media described below. A fixed storage 408 is also coupled bi-directionally to the processor(s) 401, optionally via a storage control unit 407. It provides additional data storage capacity and may also include any of the computer-readable media described below. Storage 408 may be used to store operating system 409, EXECs 410, application programs 412, data 411 and the like and is typically a secondary storage medium (such as a hard disk) that is slower than primary storage. It will be appreciated that the information retained within storage 408, may, in appropriate cases, be incorporated in standard fashion as virtual memory in memory 403.

Processor(s) 401 is also coupled to a variety of interfaces such as graphics control 421, video interface 422, input interface 423, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 401 may be coupled to another computer or telecommunications network 430 using network interface 420. With such a network interface 420, it is contemplated that the CPU 401 might receive information from the network 430, or might output information to the network in the course of performing the above-described method steps. Furthermore, method embodiments of the present disclosure may execute solely upon CPU 401 or may execute over a network 430 such as the Internet in conjunction with a remote CPU 401 that shares a portion of the processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
identifying associations among selected ones of a plurality of entities;
identifying an entity of interest from the plurality of entities;
assigning weights to entities on trajectories that connect with the entity of interest based on their associations with the entity of interest and their positions on the trajectories; and
ranking selected entities on the trajectories for the entity of interest based on their weights.

2. A method as recited in claim 1, wherein when assigning weights to entities on trajectories that connect with the entity of interest, if a first entity has a closer association with the entity of interest than a second entity, then the first entity is assigned a relatively higher weight than the second entity.

3. A method as recited in claim 1, wherein when assigning weights to entities on trajectories that connect with the entity of interest, if a third entity has a newer association with the entity of interest than a fourth entity, then the third entity is assigned a relatively higher weight than the fourth entity.

4. A method as recited in claim 1, wherein when assigning weights to entities on trajectories that connect with the entity of interest, if a fifth entity and a sixth entity are on the same trajectory and the fifth entity is closer to the entity of interest than the sixth entity, then the fifth entity is assigned a relatively higher weight than the sixth entity.

5. A method as recited in claim 1, wherein when assigning weights to entities on trajectories that connect with the entity of interest, if a seventh entity has a greater number of associations with the entity of interest than an eight entity, then the seventh entity is assigned a relatively higher weight than the eighth entity.

6. A method as recited in claim 1, wherein when assigning weights to entities on trajectories that connect with the entity of interest, a weight assigned to a ninth entity not directly connected with the entity of interest is affected by weight assigned to at least one entity in between the ninth entity and the entity of interest on a trajectory connecting the ninth entity and the entity of interest.

7. A method as recited in claim 1, further comprising:
tracking the plurality of entities; and
collecting information concerning the plurality of entities.

8. A method as recited in claim 7, further comprising:
aggregating the information concerning the plurality of entities,
wherein the information is used to identify the associations among the selected ones of the plurality of entities.

9. A method as recited in claim 1, further comprising:
categorizing the plurality of entities and their associations.

10. A method as recited in claim 1, further comprising:
applying a context filter to the plurality of entities and their associations.

11. A method as recited in claim 1, further comprising:
receiving a new weight for an entity from a user;
receiving a modification of a weight for an entity from a user; and
receiving a deletion of a weight for an entity from a user.

12. A computer program product comprising a computer-readable medium having a plurality of computer program instructions stored therein, which are operable to cause at least one computing device to:
identify associations among selected ones of a plurality of entities;
identify an entity of interest from the plurality of entities;
assign weights to entities on trajectories that connect with the entity of interest based on their associations with the entity of interest and their positions on the trajectories; and
rank selected entities on the trajectories for the entity of interest based on their total weights.

13. A computer program product as recited in claim 12, wherein when assign weights to entities on trajectories that connect with the entity of interest, if a first entity has a closer association with the entity of interest than a second entity, then the first entity is assigned a relatively higher weight than the second entity.

14. A computer program product as recited in claim 12, wherein when assign weights to entities on trajectories that connect with the entity of interest, if a third entity has a newer association with the entity of interest than a fourth entity, then the third entity is assigned a relatively higher weight than the fourth entity.

15. A computer program product as recited in claim 12, wherein when assign weights to entities on trajectories that connect with the entity of interest, if a fifth entity and a sixth entity are on the same trajectory and the fifth entity is closer to the entity of interest than the sixth entity, then the fifth entity is assigned a relatively higher weight than the sixth entity.

16. A computer program product as recited in claim 12, wherein when assign weights to entities on trajectories that connect with the entity of interest, if a seventh entity has a greater number of associations with the entity of interest than an eight entity, then the seventh entity is assigned a relatively higher weight than the eighth entity.

17. A computer program product as recited in claim 12, wherein when assign weights to entities on trajectories that connect with the entity of interest, a weight assigned to a ninth entity not directly connected with the entity of interest is affected by weight assigned to at least one entity in between the ninth entity and the entity of interest on a trajectory connecting the ninth entity and the entity of interest.

18. A computer program product as recited in claim 12, the plurality of computer program instructions are further operable to:
apply a context filter to the plurality of entities and their associations.

19. A computer program product as recited in claim 12, wherein the plurality of computer program instructions are further operable to:
categorize the plurality of entities and their associations, wherein the weights assigned to the entities with respect to the entity of interest are determined based on the categories of their associations.

20. A computer program product as recited in claim 12, wherein the plurality of computer program instructions are further operable to:
receive a new weight for an entity from a user;
receive a modification of a weight for an entity from a user; and
receive a deletion of a weight for an entity from a user.
